(19) United States
(12) Patent Application Publication
(10) Pub. No.: US 2024/0075831 A1
(43) Pub. Date: Mar. 7, 2024

(54) Method, Portable Detachable Battery, Mounted Apparatuses configured for All-Electric On-Board Vehicle Electrification.

(71) Applicants: Tommy Lee Brown, Ethelsville, AL (US); Melisha Spain, Carrollton, AL (US); Tina Latham, Carrollton, AL (US)

(72) Inventors: Tommy Lee Brown, Ethelsville, AL (US); Melisha Spain, Carrollton, AL (US); Tina Latham, Carrollton, AL (US)

(73) Assignee: PowrSmart Technologies, Inc., Ethelsville, AL (US)

(21) Appl. No.: 18/494,925

(22) Filed: Oct. 26, 2023

Related U.S. Application Data
(60) Provisional application No. 63/392,452, filed on Jul. 26, 2022.

(51) Int. Cl. B60L 53/24; B60L 53/56; B60L 53/57; B60L 53/66; B60L 53/80

(52) U.S. Cl. CPC B60L 53/24; B60L 53/56; B60L 53/57; B60L 53/66; B60L 53/80

(57) ABSTRACT

Method and high voltage platform for vehicular all-electric on-board charging and depleting of the battery system conducted safely that consists of a single, parallel, or multiple power generation set (Power Gen-Set) apparatuses where one or more of them is a converter of mechanical energy to ac or dc electricity as a primary power supply to the phase on-board charger integrated in the propulsion system. Power Gen-Sets with other electronic components create a powertrain platform that are power suppliers for replenishing dissipated power used for propulsion. The Power Gen-Sets are in communication via AI computing module and powered by a portable energy storage device that is arranged external of the vehicle that can be removed for replenishment and/or replacement.

### TECHNICAL FIELD

The present invention relates to an apparatus of an all-electric on-board charging system for a vehicle, a single, parallel, or multiple power supply to the battery storages on board of the vehicle. A method and components for generating, harvesting, converting, transferring, and storing energy as a vehicle needs it, an external dc power supply, and internal three phase power supply method. The present invention consists of a power charging device mounted in a vehicle that is powered by a portable energy storage device that is removal and replace by a replenish energy storage device.

### BACKGROUND OF THE INVENTION

The electric power grid one of a dc fast charger and a normal charger is an external power source for a power storage battery mounted as a power supply to drive an electric motor that propel electric vehicles. This method requires an attached power cord from the grid to the vehicle and charging for several minutes to hours.

Hybrid Electric Vehicles uses fossil fuels in coordination with electric on-board charging system.

Hydrogen Fuel Cell a method that uses hydrogen and although it was considered impossible to do so, recent technological developments have made it practical to construct possibly and to use a cassette as a detachable battery, even though it is a fuel cell.

### BRIEF SUMMARY OF THE INVENTION

### Problems of the Prior Art

A major concern for EV drivers and owners, is having range anxiety where the fear of running out of power before reaching their destination. Battery electric vehicles possess great potential for decreasing lifecycle costs in medium-heavy duty applications, a market segment currently dominated by internal combustion technology. Characterized by frequent repetition of similar routes and daily return to a central depot, medium-duty vocations are well positioned to leverage the low operating costs of battery electric vehicles. Unfortunately, the total cost of ownership and range limitation of commercially available battery electric vehicles acts as a barrier to widespread adoption.

However, at the present stage, how to supply electric energy to be used as a drive source of the electric vehicle, how to maintain the charged state for a long time, and how to endure the electric vehicle for long distance running. The first problem is that the storage capacity and life cycle of a battery pack such as a storage battery is not sufficient, and it is necessary to use a large but extremely heavy battery. In addition to the imposition, it is necessary to increase the load due to the increase in the weight of the vehicle body itself, so that it is not suitable for long-term or long-distance running at all. However, such a conventional battery requires 20 minutes for fast DC charging and up to ten hours or more for level two and level three charging, making it impossible to supply energy easily and efficiently to an electric vehicle. Compared with conventionally known energy supply systems such as diesel, gasoline, natural gas, etc., plugin charging is completely inferior in functionality and are one of the major factors hindering their practical use.

As one of the directions for improving the battery, a method using a battery using a fuel cell has been considered recently. However, such a fuel cell uses hydrogen as a raw material. For example, in a conventional energy station such as a gas station, an energy supply system for an electric vehicle which has a high degree of danger and by employing hydrogen proves problematic due to the high capital cost associated hydrogen as a range extending fuel, the vehicle can retain with electrical energy storage. For example, assuming a zero-emissions capability as well as the potential for electric consumption rate of 1 kWh/mi for a medium-duty operation using 100% renewably generated energy. We will refer to such a powertrain arrangement as a fuel-cell range-extended vehicle (FC-REV). The design space for a FC-REV quickly becomes complicated as the merits of battery capacity and fuel-cell power are pitted against one another. FC-REV has a 66% efficiency compared to 85% efficiency for Electric Vehicles.

However, the charging method of a small battery used in a power tool currently in practical use is to perform a charging process using a minus delta V method at a charging rate of 6 C for 10 minutes. In this method, since the battery is charged while the temperature of the battery is considerably high, the life of the battery cell is significantly shortened, and it is necessary to purchase a new battery in a short period of time. Such a charging method, for example, when applied to a method of charging a battery of an electric vehicle, an expensive and large-sized battery used in the electric vehicle must be frequently replaced. Obviously, it will be an expensive system for conventional vehicles.

In addition, electric vehicles that have been conventionally developed have an engine portion, a motor portion and a battery portion composed of a few heavy batteries for driving the motor, and a battery portion integrally attached to vehicle body, it is impossible to easily remove the battery.

A lightweight portable detachable battery has shown incremental success in smaller EV applications such as scooters, bikes, motorcycles, and ATVs utilizing battery swapping method.

Utilities fear that if charging EVs becomes common it will put tremendous stress on an aging grid.

Auto manufacturers finds it difficult to increase range without increasing battery size. Automotive OEMs, Researchers and developers feel that this method may have reached its peak. Current charging methods of charging batteries above 80 percent and depleting them below 50 percent has proven to shorten the life cycle of the batteries.

Consumers must wait several minutes to hours for a recharge. The larger the battery pack, the longer the wait and fast charging comes at a greater price. As EV's become more popular, charging spaces may become limited in heavy population areas.

### Solution to Problems

The world is constantly looking for alternative energy sources mainly due to two reasons: 1, Oil prices are constantly on the rise and 2, Oil is an infinite resource. Aside from those two reasons, the world is also looking for renewable and sustainable sources of energy in order to protect and reduce the harm caused to the environment. As you may have already noticed, the deterioration of the environment is highly correlated to the production and usage of fossil-based fuels worldwide. As a matter of fact, the United Nations (UN) has created new mechanisms to encourage the utilization and development of renewable energy resources like wind, solar panel technology, electric vehicles, electric battery storage whether in small-scale, commercial, or industrial scale. Although these technologies have made tremendous strides, they still face many challenges in order to be adopted as mainstream solutions. Transportation and power generation industries are the two top pollutants in the world. The present invention will change that by allowing automobile manufacturers to build net zero carbon emitting cars and powering them with portable batteries that can be arranged and charged using solar, wind and battery storage. These are collectively efforts that drive decarbonization and will have a positive impact on the environment and advances several UN Sustainable Development Goals.

Accordingly, an object of the present invention provides a new power source that can supplement and/or replace existing external power sources for electric vehicles or hybrid vehicles. The invention addresses the above-mentioned disadvantages of the prior art, and to supply energy to an electric vehicle that rivals the plugin EV/HEV, hydrogen, combustion diesel and gasoline-powered vehicles. An energy supply apparatus, method, and charging system for an electric vehicle is provided for all class vehicles such as automobiles, small to medium trucks, RVs, buses, motorcycles, ATVs, UTVS, semi-trucks, and off-road equipment.

In order to achieve solutions, the above-mentioned objectives, the present invention employs the following basic technical structure described in five stages: 1) Power Supply phase, 2) Power Conversion Phase, 3) Fast Charging Phase, 4) Propulsion Phase, 5) Communication Phase. The scientific process of said invention isn't to create energy out of thin air but to package available energy in order to manipulate mechanical energy into electricity that is harvested and used wherever and whenever it is needed.

Power Gen-Sets, Variable Frequency Convertor, Parallel Fast DC Charger, mini dual battery packs, AIIoT computing, couple with portable energy storage devices and Vehicle Electrification Exchange Stations are well positioned to leverage the low operating requirements as an alternative to large battery pack size to increasing range, and the utility of costs of EVs.

Therefore, the conditions required for practical use of the electric vehicle in the related art are light weight, a battery that does not place a great burden on the design of the vehicle, is easy to handle, and can complete the charging operation in a short time and ensures that the battery is fully charged or close to this in a short time. It is desired to realize a charging system that can perform a charging process by using a portable energy storage device can be arranged outside of the vehicle, that is lightweight, easy to handle, and equipped with smart technology that can communicate with the vehicle, charging stations, and drivers via mobile devices, on-board monitors, phones, or computers. A fully energize portable device can be inserted into the cavity of the vehicle to supply power to the generation system on-board.

To address another problem area of the related art, the invention that consists of a least one Power Gen-Set, a portable energy storage device, and a on board charging method is to increase the range an EV can travel before needing recharging. EVs could be improved using an all-electric high voltage on-board fast charger while in motion. Fortunately, due to the improvement of the electric motor and ac/dc generator technologies, of commercially generator that safely produces electricity at high voltage to supplement the batteries is greatly enhanced and the range limitations that acts as a barrier are removed and promote EVs to widespread adoption. This invention focuses on an all-electric on-board Power Gen-Set system couple with a reduce battery pack with integrated power supply technologies to initial propel the vehicle, to help sustain motion, to overcoming this range dilemma with portable batteries alone the range-extending route, and to hardware of choice.

Multiple portable energy storage devices are charged in vented, climate-controlled type modular Vehicle Electrification Exchange Stations that utilizes renewable energy such as solar, wind, and battery storage technologies in combination with traditional power to reduce or eliminate stress factors that would be place upon the utility grids as EV charging becomes mainstream.

The invention address range anxiety by the mass adoption of modular Vehicle Electrification Exchange Stations. These stations can be installed easier, quicker, cheaper than hydrogen fuel cell or gasoline and diesel stations. The flexibility of Vehicle Electrification Exchange Stations networks can be utilizing in build out a massive charging infrastructure i.e., the gas station model, workplace charging, private fleet management, public transit, and community and residential in some areas.

The invention consists of an all-electric on onboard charging systems used in collaboration with a portable detachable battery that is charged in modular stations provides industry transformation and benefits such as extending the range of battery electric vehicles as a means of improving utility, and presumably, increasing market adoption. Vehicle Electrification Exchange Stations provide EV owners and drivers the flexibility to have readily available power source without having to wait periods of time, therefore limited charging spaces will not be an issue.

The on board computing and software for the invention analysis employs real-world vocational data and near-term economic assumptions to help EV adoption become scalable through (1) identify optimal component configurations for minimizing lifecycle costs, (2) benchmark economic performance relative to both battery electric and drive motor powertrains, and (3) understand how the optimal design and its competitiveness change with respect to duty cycle and economic climate (4) Power Gen-Sets units configurations provide extended range at significantly lower capital and lifecycle costs than additional battery capacity alone (5) Battery Management System, Power Gen-Set Controllers, and Supplement and Auxiliary power communication technology embedded in the software ensures excellent performance and safety (6) Artificial Intelligence, GPS, Internet of Things and Biometric technologies to optimize consumer network subscriptions, fintech payment, data security, routing, product and service availability, and integrated upgrades and updates.

With the market segment currently dominated by internal combustion engines, present-day capital cost of EVs already significantly higher technology. Characterized by frequent repetition of similar than CVs, the notion of increasing vehicle range exclusively routes and daily return to a central depot, medium duty through electrical energy storage is difficult to justify. And while fuel-cell range-extended vehicles are not deemed economically competitive with conventional vehicles given present-day economic conditions, the invention identifies potential future scenarios where cost equivalency is achieved through similar modifications.

Auto manufactures may prefer a singular range requirement that could be satisfied using a few different hardware configurations ranging from a low capital cost, generator/alternator-dominant design to an operating multi-Power Gen sets design. Due to technology advancements in the electric brushless motor and brushless ac/dc generator industries, the invention requires little to no maintenance because there are fewer moving parts. The design space is further expanded by considering at what point during the depletion of the battery to engage the Power Gen-Sets. While much hardware/software combinations capable of meeting a given range requirement exist, exploring the design space to identify a cost-optimal solution is a non-trivial task. The drawing section illustrates a methodology for identifying optimal Power Gen-Sets, battery pack, and portable detachable battery designs given inputs such as components and schematics.

### DESCRIPTION OF DRAWINGS

The above and other features of the present invention will now be described in detail with reference to certain exemplary embodiments thereof illustrated the accompanying drawings which are given herein below by way of illustration only, and thus are not limitative of the present invention, and wherein:

FIG. 1 (Related Art) is a schematic view illustrating the configuration of an on-board charging platform of an all-electric vehicle powered by a detachable battery, AI computing module, Power Gen-Set, an on-board charger, a specialty configurated battery pack, transformer, Aux & Communication interface unit, battery management system, inverter and a drive motor, on-board monitor.

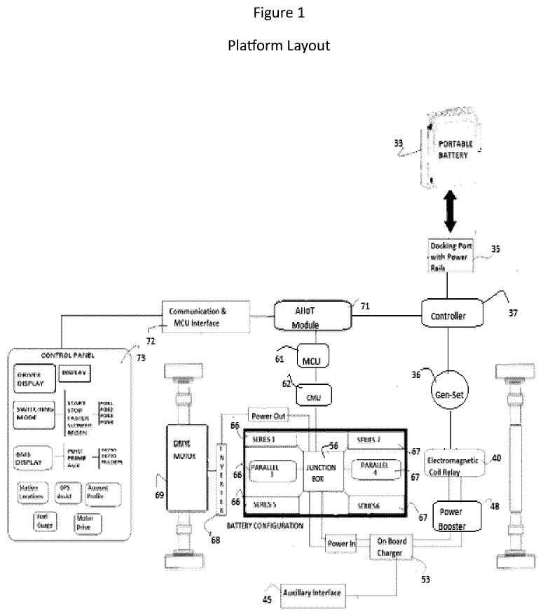

FIG. 2 (Related Art) is a schematic view illustrating of multiple Power Gen-Sets and method for vehicular electrification powered by portable battery, Power Gen-Sets is several apparatuses to convert mechanical energy into ac or dc power. The mounted apparatus is a single housing primary power generator that has a power generation unit for generating electric power, a rotary unit that is powered by a portable energy storage device.

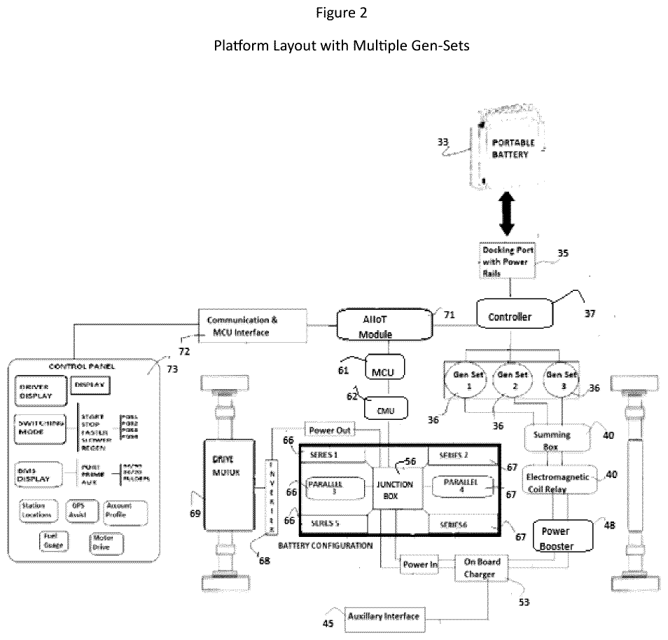

FIG. 3 (Related Art) is a schematic view illustrating the configuration & switching method of the battery pack to improve battery cell life cycle. The design is a hybrid pack with battery cells arranged in sections of series and parallel modules. Power is harvested and throughout the pack from integrated components designed and installed within the housing of the pack. The design is to sustain charging and depleting process and apply power to drive motor while in motion.

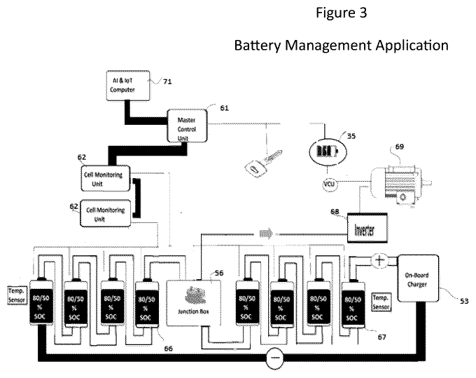

FIG. 4 (Related Art) is a schematic view illustrating the configuration of the Battery Management System that is comprised of a Master Control Unit (MCU) and Cell Monitor Units (CMU).

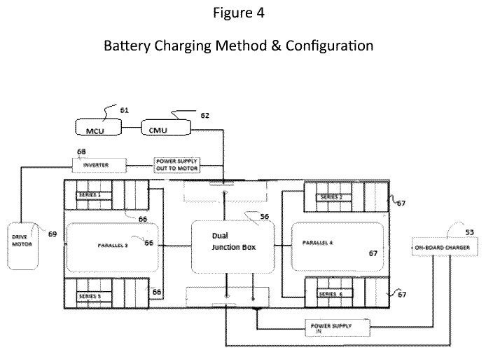

FIG. 5 (Related Art) is a schematic view illustrating the configuration of a modular portable battery charging station that uses traditional power, renewable energy, and on-site battery storage as a charging source. The illustrated designs and other components that make up a charging platform for purpose of research and development, licensing, and commercial use can provide more in-depth details and claims in division patents.

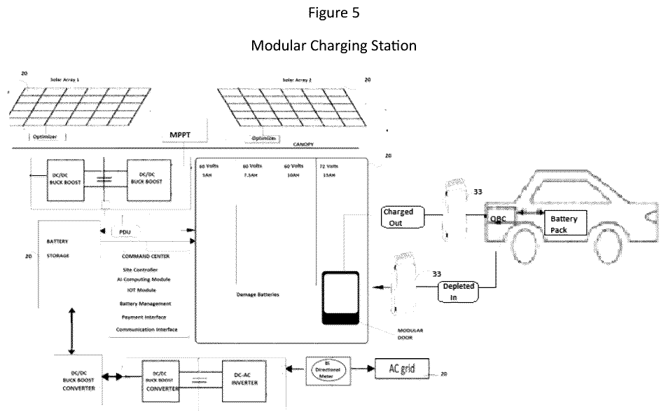

### DETAILS OF INVENTION

The present invention employs the following basic technical structure described in five stages: 1) Power Supply phase, 2) Power Conversion Phase, 3) Fast Charging Phase, 4) Propulsion Phase, 5) Communication Phase

The description of the invention begins with the Power Supply Phase external of the vehicle with a portable energy storage device with the features of a small suitcase casing. The small energy storage device is small light weight that can be easily handle as well as equipped with smart technology devices for communication, charging and discharging efficiency, tracking and tracing, safety protection, and energy storage and management. It is desired to realize a charging system that can perform a charging process by using a portable energy storage device can be arranged outside of the vehicle, that is lightweight, easy to handle, and equipped with smart technology that can communicate with the vehicle, charging stations, and drivers via mobile devices, on-board monitors, phones, or computers. A fully energize portable device can be inserted into the cavity of the vehicle to supply power to the generation system on-board.

The Portable Energy Storage Device is arranged in a modular Vehicle Electrification Exchange Stations that is powered using renewable energy such as solar and wind. Traditional grid power is used in conjunction as a backup source of energy to help power the EVs battery swapping stations.

Electric vehicle owners can remove the depleted energy storage device from the docking slot located in a cavity of the vehicle and insert a full charged device that is retrieved from the modular battery charging and exchange station. The fully charged battery is inserted in the docking port that has built in power rails for battery security, load connect/disconnect, over V/I protection, LDO, PMIC, HV Buck and climate-controlled devices.

Power from the Portable Energy Storage Device is then transfer via cable to a mounted apparatus which is a single housing of one or more dc powered motors directed connected via shaft to single phase output generators known as the Primary Power Gen-Sets. The purpose of the Gen-Sets is to use dc power and convert mechanical energy into a constant stream of single-phase power. The vehicle powertrain design can utilize a single or multiple Portable Energy Storage Devices depending on the size and other characteristics of the vehicle and Power Gen-Sets sizing.

Start/stop and speed controller device is an important part of the design. A single Power Gen-Set controllers are used based on the design. The controller plays a vital role in the speed of the dc motor of the Gen-Set and engaging and disengaging attachments to the generators. An encoder or hall version in the motor of the Gen-Set is used in communication via controller and the AI computer module is an example that can goes into a design.

A portable detachable battery used in combination with a docking port with power rails, controller and Power Gen-Sets are all mounted apparatus that make up the power supply phase. This phase is for the purpose of generating a constant supply of single-phase ac energy to supply the components in the platform and by supplying power to battery cells that is arranged in parallel and arranged in series providing power to the electric drive motor.

As a first aspect of the electric vehicle energy supply system according to the present invention, a mounted single or multiple (Power Gen-Sets). These power generator sets are driven by a motor with a detachable battery and can be installed in several generator combinations like motor shaft direct or belt driven connected to the generator, or a small motor wind or water turbine from an internal rotary unit for the purpose of generating electricity to be supplied to the power conversion phase. These are a few mentioned combinations but not limited to, but they all have the commonality of being powered by a portable detachable battery.

One other component used to assist in the power supply process is a junction box with voltage summing circuits and pass on to an electromagnetic coil for switching power supply on/off. Such circuits are needed when using more than one Power Gen-Set. Below is example of a summing circuit used to combine two or more voltage supply. The formula to increase voltage is as follow:

Total Voltage=V1+V2+V3

The voltage output can be added for three 48 volts DC Power Gen-Set in series.
The total output is 144V DC.
Increasing AC Voltage is the same as increasing DC voltage. To increase the voltage, we connect the AC voltages in series to get a higher output voltage. If the frequency of all the voltages is the same, the magnitude of the voltages is simply added.
Look at the example below:
The voltages will just add, so the total voltage will be 28 Vac at 60 Hz. The amperage will be the value of the power supply of the least current.
If the frequencies are different, then the voltages still add, but not directly. They must be converted to complex form and then added because they are different frequencies. In some designs, each Gen-Set is isolated and supplied input and output can vary. More Power Gen Sets can be added to allow for greater power production for larger vehicles, trucks, buses, and off-road equipment. Brushless ac/dc generators are used because they have fewer moving parts and requires less maintenance. Rotatory fans can be attached to shaft of the ac/dc generators or the housing to keep them cool. The voltage sizing of the Gen-Sets output comes in several variants (110 v, 220 v, 440 v, 480 v, etc.) depends on size, class, and type vehicle. The voltage that supplies electricity to the conversion and power boosting process is computed by the number of ac/dc generators used in the design.

After the proper power is supplied in the first phase, it is transferred to the Conversion Phase where it is harvested and converted to three phase power. This stage is conducted utilizing a newly designed component called a Variable Frequency Convertor (VFC).

The Conversion phase or power boost phase is to replicate the abundance supply of single-phase power to clean, constant, three phase power that will be needed in the fast-charging phase. Three phase power is three times more efficient than single phase power.

The VFC is a multifunction power conversion that is small enough to integrated in the electric vehicle propulsion process. It can be programmed to convert single phase power to three phase power.

The conversion phase is also where ac power is converted to low voltage dc power to supply to the auxiliary interface component. This process is conducted within the VFC.

An Aux and Master Control unit module interface is in communication to the VFC and AI for power supply monitoring to operate all the electronics and charging the auxiliary battery. It can also serve as a reserve battery for another safety tool of the invention. Once the battery pack has reached a stated charged capacity, additional power can be dumped unto the Aux Battery modules, or a battery separated from the battery pack.

The Variable Frequency Convertor also boosts the desired voltage for instance from 220V to 380V, 400V, 440V, etc. The desired voltage should be enough to constant supply and sustain the fast charger in the next phase.

To ensure the proper power to the power booster, an electromagnetic coil relay is used to enhance or control supply. Regardless of the design chosen, they all serve the same purpose is to supply energy to the power booster and on to the on-board charger and then to the battery pack and the auxiliary interface.

The power booster phase or conversion phase is based on the desired design as a transformer, inverter, VFD drive, or boost convertor that can be used to step up, enhance, convert ac to dc, and supply power to an on-board charger where dc power distributed to the aux interface and the battery pack for the inverter and drive motor. An ideal design will be using an isolated transformer that supply power to OBC that uses two half-bridge power boards that power a hybrid battery pack. The transformer design example is as followed.

The VFC was designed with several parameters in mind, such as input frequency resolution, and the carrier frequency is automatically adjusted based on the load features and data from the charge and propulsion phases.

The Variable Frequency Convertor supports communication via CANopen, CANlink, PROFIBUS-DP, Modbus-RTU.

Once power has cleared the Conversion Phase, it is then transferred to the Fast-Charging Phase. The Fast-Charging Phase is to replicate the power solution to that of a Fast DC Charger that is common amongst plugin electric vehicles. These chargers are large, heavy, and expensive.

In the Fast-Charging Phase, a newly designed charger that is slim down, less expensive, but provide similar functions can charge the battery pack using the same amount or above power levels used by the traction motor in the propulsion system.

The fast on-board charger is made up of a series of power devices. There are several examples of an OBC, such as SiC MOSFETs a compact chip size power converter resulting in faster operation, reducing switching loss. They are available in six variants (650V/1200V) that features approx. 50% lower ON resistance than 2 nd generation planar types. A special designed OBC for the present invention function as a 3 into 1 device that can isolate the power provided from the Power Gen-Sets that are installed on board.

The three-phase integrated charger proposed utilizes a simple connection on the positive, negative, and neutral of the Variable Frequency Convertor. However, the propulsion system is modified to install the contactor between the motor/inverter and the power mains of the battery pack where power is distributed, and no switching components are required.

The three-phase integrated fast charging approaches proposed needs access to the neutral point of the VFC instead of the traction motor windings, which is not available for conventional three-phase propulsion systems. Moreover, the freewheeling diodes, connected to the neutral point of motor windings, would conduct in propulsion mode, and disable the normal operation. Thus, the freewheeling diodes would have to be disconnected from the propulsion system in propulsion mode to prevent disable of normal operation. Therefore, accessing the neutral point of the VFC is a better option to prevent disruptions in operations of the charger.

The proposed fast charger utilizes a three-phase input and parallel charging output. The output makes connections with the junction box of the battery pack as two positive and negative contactors. The output makes the proposed charger capable of charging dual min battery packs at the same time or separate timeframes without the need for switching devices which would cause more power losses.

Changing the charging patterns within the proposed charger eliminates the need for using switches between the battery pack and the fast charger but switching may be needed in the output of the battery pack supplying power to the inverter/motor.

The proposed three-phase integration method is implemented by directly connecting the proposed small three-phase interface to two terminals of propulsion system. The propulsion motor is utilized as a coupled DC inductor, and the switches of the traction converter are utilized to construct the charger. A three-phase interface fast dc charger, mainly composed of switches and has small size. The integrated scheme enables onboard charging due to the small size of the three-phase add-on Variable Frequency Converter.

The charger topology is capable of three-phase power factor correction (PFC) and regulating the battery voltage/current.

Other hardware in the Fast-Charging Phase includes a complex Battery Management System (BMS) to manage the power of the battery pack. The BMS is based on two board types, the Main Control Unit (MCU) and the Cell Monitoring Unit (CMU).

The MCU is the main board controlling the slave boards and communicating with external devices.

The CMUs are the cell measurement boards, which are connected to the battery cells. Each CMU can measure the voltage and temperature of up to 12 cells. Up to 32 CMU boards can be connected, serving up to 384 cells for a maximum battery voltage of 1000 V.

The power to the Main (MCU) functions are provided from an external 12V power source (e.g a lead acid battery or via a DC/DC converter from the main battery), while the power to the Cell Monitoring Units is provided directly from the main battery.

A junction box and the Battery Management System (BMS) is configured with four hardware modules, one Master Control Unit (MCU) that is connected to the AI computing module, two Cell Monitor Units (CMU) in the battery pack that send and receive data to the MCU, and one CMU in the portable detachable battery. This system utilizes voltage sensing to avoid damage form over voltage that can occur during charging and from under-voltage that can occur during excessive discharging. The primary mode is the 80/50 charge sustaining (CS). The 80/50 method strikes the balance of not allowing the battery pack to exceed 80 percent charged capacity and not discharge below 50 percent capacity. Continuous use of this method increases the life cycle of the battery pack. The driver can override the 80/50 mode to depleting (CD) battery operation where the battery charge can discharge below the 50 percent capacity level as in a non-plug-in fuel-cell hybrid electric vehicle, or FC-HEV). The vehicle initially operates in charging state (CS) mode using the Power Gen-Sets that is powered by the portable storage device only. In the CS phase, the Power Gen-Sets supplies the average power needed to propel the vehicle and maintain the state of charge (SOC) and switches to REGEN mode after the Portable Energy Storage device reaches a low state of charge (SOC) or depleted threshold. The vehicle owner receives a warning notice of low (SOC) and is required to replace the Portable Energy Storage Device or the vehicle will become in operatable, like a low fuel gauge light warning on a combustion vehicle and then running out of gas. This operating philosophy maximizes the use of inexpensive on-board electricity, and the driving range is limited only by the amount of obtainable capacity of the portable energy storage device.

Much emphasis has been placed on the configuration and design of the Battery Pack. Power Gen-Sets and a configuration of charging methods allow auto makers the opportunity to reduce the size of the battery packs while at the same instance extending the travel range. The pack is equipped with switching technology via communication from the BMS cell monitoring modules to ensure all cells maintain the proper power supply.

The battery configuration is arranged in two section of battery cells in series and parallel. The first section arranged in two set series and one set of parallel 1, 3, 5 with supplemental power provide electricity to the electric drive motor for propulsion until the SOC is drained to 50% capacity.

Once the SOC reaches 50% or below, the BMS alerts the fast DC charger to switch the power supply to drive motor from the other section 2, 4, 6 of battery cells in series with one parallel power supply and while the SOC for 1, 3, 5 is being charged to 80 percent capacity. This process continues as long as the portable battery has enough power to supply the Gen-Sets.

A design that uses an inverter application to convert DC power to AC power to provide electricity to the drive or traction motor(s). The inverter receives high voltage DC power from the battery pack and regulates it to the traction motors is the final phase of the fast-charging process.

The next phase of the present invention is the Propulsion Powertrain stage. The vehicle is propelled by an electric drive motor attached to the wheels via axles that can be installed in front or rear wheel drive. The design can be a single or multiple motors attached to the wheels of the vehicle as well as transmission or differential axle. These motors are manufactured in several types and sizes that can be integrated into the propulsion phase.

The present invention deploys a communication and monitoring phase as a final step in the platform. This phase ensures the proper functioning of the powertrain system, assist in preventive maintenance, system data management to improve driver experiences, and integration of software and hardware.

AIIoT Computer module is installed in communication with docking port to carry out several functions. Those functions include but not limited to controlling the Power Gen-Sets, managing power distribution, and switching, monitoring data with BMS in the battery pack, the portable battery, and Aux Battery that communicate via Bluetooth, CAN Peak driver, aux interface and driver monitor, cell phone or pc devices. IoT hardware is installed in conjunction with the AI Computer module to provide the EV owner with global cellular connectivity or Wi-Fi to securely move data concerning the powertrain platform.

Battery Management System is integrated into the system which includes the Master Control Unit (MCU) and is in constant CAN communication interfaces with the computer and the Cell Monitor Unit (CMU). The CMU balances cells within the battery modules as well as temperature data, power supply, SOC, open wire detection, leak detection, and error diagnostics.

On-Board Computing places a vital role in the successful operation of the invention. A monitor or display is provided to assist the driver in knowing the operating status or any overrides of the platform. This includes temperature of the devices and batteries, Gen-set modes, SOC, and internal/external tasks.

What is claimed is:

1. A method and an all-electric on-board charging platform powered by a detachable battery for electric vehicles.

2. A process of a first DC voltage power device powered by a DC detachable battery for start and stop functions of a generator set to provide aux power, and as well as supplemental power to the battery pack. A second and third voltage device separated or in parallel or series to providing power for replenishing of the battery pack.

3. A method and an all-electric on-board charging platform powered by a portable dc detachable battery that can be utilized as charge as you go in all class of vehicles as well as off-road equipment. The platform consists of energy supply apparatuses, method, and charging system for an electric vehicle for all class vehicles such as automobiles, small to medium trucks, RVs, buses, motorcycles, ATVs, UTVS, semi-trucks, and off-road heavy equipment.

4. A plurality of AC or DC power generator set apparatuses embedded or attached anywhere along the front, rear, or sides for conversion of mechanical energy to electricity for the purpose of charging or replenishing the battery pack. This includes a bar, shaft, chain, belt or in wheel technologies that uses mechanical energy provided by a vehicle that is propelled by an electric platform and a portable detachable battery.

5. A method and specialty designed on board charger (OBC) that isolate power from the Primary Power Gen-Set from the electricity provided by single, parallel, or multiple Power Gen-Sets. The single or multiple Power Gen-Set can be designed to bypass the OBC and provide power directly to the battery pack.

6. Power Gen-Sets can be arranged in several combinations and use many sources to propel generators such as but not limited to motors, wind turbine, electromagnetic coils, water pumps, steam pressure etc. for purpose of generating power to be supplied to the battery pack and powered by a detachable battery on an electric vehicle.

7. A method and designing of a reduced battery pack configurations to improve the life cycle by aligning battery cells in series and parallel in sections to provide enough power to account for propulsion considering weight, speed, size, traction of the vehicle. While some sections are being dispersed of power, other sections are been charged. Each section been charged or discharged based on 80% maximum charged and 50% discharged principles and switching coordination by the battery management system.

8. A portable detachable battery for the purpose of powering an all-electric charging EV platform comprising of intelligence, communication, tracking & tracing technologies for purpose of providing data and services to the EV on board computing and EV battery charging exchange stations.

9. A portable detachable battery for the purpose of powering an all-electric charging EV platform can be arranged and charged in venting and climate-controlled type charging stations with voltage of 12V, 24V, 48V, 56V, 72V, etc.

10. Portable detachable battery, docking outlet will comprised power rails such as load disconnect and over V/I protection, AI computing, and single, or multiple Power Gen-sets used in collaboration as the starting point of supplying power to vehicles of all classes.

11. Method for powering and all-electric charging EV platform that can encompass a plurality of detachable batteries and Primary Power Gen-Sets designs.

12. The high voltage platform powered by a detachable battery can supply energy to a single electric motors or multiple drive motors for the propulsion of an electric vehicle.

13. The uniqueness of the state art is the ability to power the battery pack or increase the range for long period of times of an electric vehicle by inserting a portable detachable battery into a cavity of the automobile or equipment.

14. The platform can be design for the Power Gen-Sets to supply power to the battery pack cells that are arranged in series. The platform can be design for the Parallel Power Gen-Set to supply power to the battery pack cells that are arranged in parallel. The secondary Power Gen-Sets can be arranged in series or provide isolated power.

15. The method of the stated art creates a simplified process for charging vehicles. First it allows EV drivers to battery exchange at charging stations without having to wait in contrast to plugin chargers.

16. The method of the stated art can service thousands of vehicles in a single location using renewable energy, in contrast where plugin chargers require multiple sites and equipment. The business process can rival the gas station model.

17. The method and technology used in the related art promote several United Nations Sustainable Development Goals concerning the environment such as affordable and clean energy, climate action, and industry, innovation, and infrastructure. The method and technology used in the related art promote several United Nations Sustainable Development Goals that have social impact such as decent work and economic growth, responsible consumption and production.

18. The method and technology used in the related art promote several United Nations Sustainable Development Goals that create strong governance principles such as sustainable cities and communities, partnerships for goals.

19. The first of its kind electric vehicle platform that allows the battery pack to be charged and discharged as the vehicle is in motion and the power source comes from dc portable detachable battery.
